(19) United States
(12) Patent Application Publication
(10) Pub. No.: US 2026/0025598 A1
(43) Pub. Date: Jan. 22, 2026

(54) IMAGE PROCESSING DEVICE AND IMAGE PROCESSING METHOD

(71) Applicant: SK hynix Inc., Gyeonggi-do (KR)

(72) Inventors: Cheol Jon JANG, Gyeonggi-do (KR); Dong Ik KIM, Gyeonggi-do (KR); Jin Na YANG, Gyeonggi-do (KR); Jun Hyeok CHOI, Gyeonggi-do (KR)

(21) Appl. No.: 19/267,648

(22) Filed: Jul. 14, 2025

(30) Foreign Application Priority Data
Jul. 19, 2024 (KR) 10-2024-0095619

(51) Int. Cl. H04N 25/68; H04N 17/00

(52) U.S. Cl. CPC H04N 25/68; H04N 17/002

(57) ABSTRACT

An image processing device includes: a checkered pattern determiner configured to determine whether a texture within a kernel including a target pixel has directionality of a predetermined checkered pattern; a diagonal pattern determiner configured to determine whether the texture has directionality of a diagonal pattern when the texture does not have the directionality of the predetermined checkered pattern; and a target pixel corrector configured to correct the target pixel based on a result of a determination obtained by the checkered pattern determiner and the diagonal pattern determiner.

### CROSS-REFERENCE TO RELATED APPLICATION

The present application claims priority under 35 U.S.C. § 119(a) to Korean patent application number 10-2024-0095619, filed on Jul. 19, 2024, the disclosure of which is incorporated herein by reference in its entirety.

### TECHNICAL FIELD

Embodiments of the present disclosure relate to an image processing device and an image processing method.

### BACKGROUND

Image sensing devices are devices for capturing optical images by converting light into electrical signals using a photosensitive semiconductor material which reacts to light. With the development of automotive, medical, computer and communication industries, the demand for high-performance image sensing devices is increasing in various fields such as smartphones, digital cameras, game machines, IoT (Internet of Things), robots, security cameras and medical micro cameras.

An original image captured by the image sensing device may include an image that does not correspond to a normal image due to defective pixels. A defective pixel may have an inability to display color or light or may display a fixed color or light when they should be changing. Since the quality of the image deteriorates due to such defective pixels, a process for correcting the image affected by the defective pixels is desirable.

### SUMMARY

Various embodiments of the present disclosure relate to an image processing device capable of correcting a target kernel belonging to a kernel that includes a texture having directionality of a checkered pattern.

Various embodiments of the present disclosure relate to an image processing device capable of determining whether a texture in a kernel has directionality of a checkered pattern.

Various embodiments of the present disclosure relate to an image processing device capable of correcting a target pixel using pixels having the same color as the target pixel.

Various embodiments of the present disclosure relate to an image processing device capable of determining whether a texture in a kernel has directionality of a diagonal pattern.

In accordance with an embodiment of the present disclosure, an image processing device may include: a checkered pattern determiner configured to determine whether a texture within a kernel including a target pixel has directionality of a predetermined checkered pattern; a diagonal pattern determiner configured to determine whether the texture has directionality of a diagonal pattern when the texture does not have the directionality of the predetermined checkered pattern; and a target pixel corrector configured to correct the target pixel based on a result of a determination obtained by the checkered pattern determiner and the diagonal pattern determiner.

In some implementations, the checkered pattern determiner may determine whether the texture has the directionality of the predetermined checkered pattern based on a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel.

In some implementations, the checkered pattern determiner may determine whether the texture has the directionality of the predetermined checkered pattern based on whether a first direction corresponding to a maximum gradient sum among the vertical gradient sum, the horizontal gradient sum, the slash-directional gradient sum, and the backslash-directional gradient sum is perpendicular to a second direction corresponding to a minimum gradient sum among the vertical gradient sum, the horizontal gradient sum, the slash-directional gradient sum, and the backslash-directional gradient sum.

In some implementations, the checkered pattern determiner may determine whether the texture has the directionality of the predetermined checkered pattern based on whether a value obtained by multiplying a minimum gradient sum among the vertical gradient sum, the horizontal gradient sum, the slash-directional gradient sum, and the backslash-directional gradient sum by a first ratio is greater than the remaining gradient sums excluding the minimum gradient sum.

In some implementations, the checkered pattern determiner may determine whether the texture has the directionality of the predetermined checkered pattern based on a first sum value, a second sum value, a third sum value, and a fourth sum value. The first sum value is obtained by summing a first gradient sum for a first row of the kernel, a second gradient sum for a first column of the kernel, a portion of a third gradient sum for a last column of the kernel, and a portion of a fourth gradient sum for a last row of the kernel; the second sum value is obtained by summing the first gradient sum, the third gradient sum, a portion of the second gradient sum, and a portion of the fourth gradient sum; the third sum value is obtained by summing the third gradient sum, the fourth gradient sum, a portion of the first gradient sum, and a portion of the second gradient sum; and the fourth sum value is obtained by summing the second gradient sum, the fourth gradient sum, a portion of the first gradient sum, and a portion of the third gradient sum.

In some implementations, the checkered pattern determiner may determine whether the texture has the directionality of the predetermined checkered pattern based on whether a minimum sum value among the first to fourth sum values is less than a value obtained by multiplying an average luminance value of the kernel by a second ratio.

In some implementations, the checkered pattern determiner may calculate the average luminance value of the kernel using an average value of values obtained by removing offset values from pixel values of green pixels within the kernel.

In some implementations, the checkered pattern determiner may calculate the first to fourth gradient sums using pixels having the same color as the target pixel.

In some implementations, the checkered pattern determiner may determine whether the texture has the directionality of the predetermined checkered pattern based on whether a value obtained by subtracting a minimum sum value among the first to fourth sum values from a maximum sum value among the first to fourth sum values is greater than a value obtained by multiplying an average luminance value of the kernel by a third ratio.

In some implementations, the diagonal pattern determiner may determine that the texture does not have the diagonal pattern directionality, when, among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel, the slash-directional gradient sum is at a minimum value; when a fifth gradient sum of adjacent pixels of the target pixel and other pixels located in a slash direction from the adjacent pixels is greater than a value obtained by multiplying an average luminance value of the kernel by a fourth ratio; and when the slash-directional gradient sum is greater than the average luminance value of the kernel.

In some implementations, the diagonal pattern determiner may determine that the texture does not have the diagonal pattern directionality, when, among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel, the backslash-directional gradient sum is at a minimum value; when a sixth gradient sum of adjacent pixels of the target pixel and other pixels located in a backslash direction from the adjacent pixels is greater than a value obtained by multiplying an average luminance value of the kernel by a fourth ratio; and when the backslash-directional gradient sum is greater than the average luminance value of the kernel.

In some implementations, the target pixel corrector may correct the target pixel based on a third direction when the texture has directionality of the predetermined checkered pattern, wherein the third direction corresponds to a second smallest gradient sum among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel.

In some implementations, the target pixel corrector may correct the target pixel using an average value of pixel values of pixels that are located in the third direction from the target pixel and have the same color as the target pixel.

In some implementations, the target pixel corrector may correct the target pixel based on a fourth direction when the texture does not have the directionality of the predetermined checkered pattern and does not have the diagonal pattern directionality, wherein the fourth direction corresponds to a smaller gradient sum among a vertical gradient sum of at least some pixels of the kernel and a horizontal gradient sum of the at least some pixels of the kernel.

In some implementations, the target pixel corrector may correct the target pixel using an average value of pixel values of pixels that are located in the fourth direction from the target pixel and have the same color as the target pixel.

In some implementations, the target pixel corrector may correct the target pixel using an average value of pixel values of pixels having the same color as the target pixel within the kernel, when the texture does not have the directionality of the predetermined checkered pattern and has the diagonal pattern directionality.

In some implementations, the target pixel corrector may correct the target pixel using a median value of pixel values of pixels having the same color as the target pixel within the kernel, when the texture does not have the directionality of the predetermined checkered pattern and has the diagonal pattern directionality.

In some implementations, the target pixel corrector may correct the target pixel based on a specific direction when the texture does not have the directionality of the predetermined checkered pattern and has the diagonal pattern directionality, wherein the specific direction corresponds to a minimum gradient sum among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel.

In accordance with another embodiment of the present disclosure, an image processing device may include: a checkered pattern determiner configured to determine whether a texture within a kernel has directionality of a predetermined checkered pattern based on a gradient sum of at least some pixels within the kernel including the target pixel; and a target pixel corrector configured to correct, when the texture has the directionality of the predetermined checkered pattern, the target pixel based on a direction corresponding to a second smallest gradient sum among a vertical gradient sum of the at least some pixels, a horizontal gradient sum of the at least some pixels, a slash-directional gradient sum of the at least some pixels, and a backslash-directional gradient sum of the at least some pixels.

In accordance with another embodiment of the present disclosure, an image processing method may include: determining whether a texture within a kernel including a target pixel has directionality of a checkered pattern based on gradient sums for each of a first row, a last row, a first column, and a last column of the kernel including the target pixel; and correcting the target pixel based on a result of the determining.

It is to be understood that both the foregoing general description and the following detailed description of the present disclosure are illustrative and explanatory and are intended to provide further explanation of the present disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an example of an image processing device according to an embodiment of the present disclosure.

FIG. 2 is a diagram illustrating an example of a checkered pattern according to an embodiment of the present disclosure.

FIG. 3 is a diagram illustrating an example of a checkered pattern according to an embodiment of the present disclosure.

FIG. 4 is a flowchart illustrating an example of an image processing method according to an embodiment of the present disclosure.

FIG. 5 is a schematic diagram illustrating example operations of the image processing method according to an embodiment of the present disclosure.

FIG. 6 is a flowchart illustrating an example of an image processing method according to an embodiment of the present disclosure.

FIG. 7 is a schematic diagram illustrating example operations of the image processing method according to an embodiment of the present disclosure.

FIG. 8 is a schematic diagram illustrating example operations of the image processing method according to an embodiment of the present disclosure.

FIG. 9 is a flowchart illustrating an example of an image processing method according to an embodiment of the present disclosure.

FIG. 10 is a block diagram showing an example of a computing device corresponding to the image processing device of FIG. 1, according to an embodiment of the present disclosure.

### DETAILED DESCRIPTION

The present disclosure provides implementations and examples of an image processing device and an image processing method that may be used in configurations to substantially address one or more technical or engineering issues and to mitigate limitations or disadvantages encountered in some other image processing devices. Some implementations of the present disclosure relate to an image processing device that corrects a target kernel belonging to a kernel that includes a texture having directionality of a checkered pattern. Some implementations of the present disclosure relate to an image processing device that determines whether a texture in a kernel has directionality of a checkered pattern. Some implementations of the present disclosure relate to an image processing device that corrects a target pixel using pixels having the same color as the target pixel. Some implementations of the present disclosure relate to an image processing device that determines whether a texture in a kernel has directionality of a diagonal pattern. In recognition of the issues above, the present disclosure may provide an image processing device that corrects a target kernel belonging to a kernel that includes a texture having directionality of a checkered pattern. The present disclosure may provide an image processing device that determines whether a texture in a kernel has directionality of a checkered pattern. The present disclosure may provide an image processing device that corrects a target pixel using pixels having the same color as the target pixel. The present disclosure may provide an image processing device that determines whether a texture in a kernel has directionality of a diagonal pattern.

Reference will now be made in detail to the embodiments of the present disclosure, examples of which are illustrated in the accompanying drawings. Wherever possible, the same reference numbers will be used throughout the drawings to refer to the same or like parts. While the present disclosure is susceptible to various modifications and alternative forms, specific embodiments thereof are shown by way of example in the drawings. However, the present disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein.

In the following description of embodiments of the present disclosure, a detailed description of known functions and configurations incorporated herein will be omitted when it may make the subject matter of the present disclosure rather unclear. In the drawings, parts that are not related to a description of the present disclosure are omitted to clearly explain the present disclosure and similar reference numbers will be used throughout this specification to refer to similar parts.

In the present disclosure, when a component is referred to as being “connected”, “coupled”, or “joined” to another component, it may include not only a direct connection relationship but also an indirect connection relationship in which another component is present therebetween. In addition, when a component “comprises”, “includes” or “has” another component, this means that the component does not exclude other components unless specifically stated above but may further include other components.

In the present disclosure, terms such as “first”, “second”, etc. are used only to distinguish one element from other elements and is not used to limit elements, and unless otherwise specified, it does not limit an order or importance, etc. of elements. Accordingly, within a scope of the present disclosure, a first element in an embodiment may be referred to as a second element in another embodiment and likewise, a second element in an embodiment may be referred to as a first element in another embodiment.

In the following description, components are discriminated from each other to clearly describe their characteristics, but this does not mean that they are necessarily physically separated. That is, a plurality of components may be integrated into one hardware or software module and one component may be divided into a plurality of hardware or software modules. Accordingly, integrated or divided embodiments are within the scope of the present disclosure even if not specifically stated.

In the following description, components described with reference to various embodiments are not all necessarily required and some components may be selectively used. Accordingly, embodiments composed of some of the components described in one embodiment are also within the scope of the present disclosure. Further, embodiments implemented by adding components to various embodiments are also within the scope of the present disclosure.

In the present disclosure expressions of positional relationships used in the present specification such as “top”, “upper”, “bottom”, “lower”, “left”, “right”, etc. are employed for the convenience of explanation, and when the drawings illustrated in the present specification are viewed in reverse, the positional relationships described in the specification may be interpreted in the opposite way.

In the present disclosure, each of phrases such as “A or B”, “at least one of A and B”, “at least one of A or B”, “A, B or C”, “at least one of A, B and C”, “and “at least one of A, B, or C” may include any one or all possible combinations of the items listed together in the corresponding one of the phrases. In description of the present disclosure, the term “and/or” may include a combination of a plurality of items or any one of a plurality of listed items. For example, “A or B” may include “only A”, “only B”, or “both A and B”.

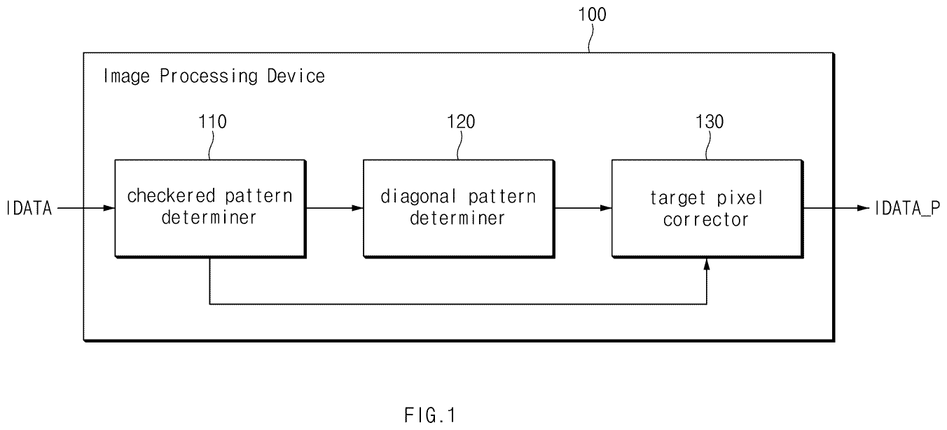

Hereinafter, embodiments of the present disclosure will be described in detail with reference to FIGS. 1 to 10.

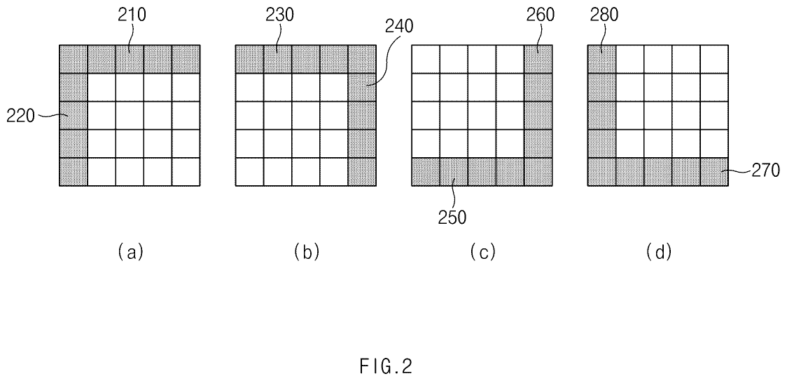

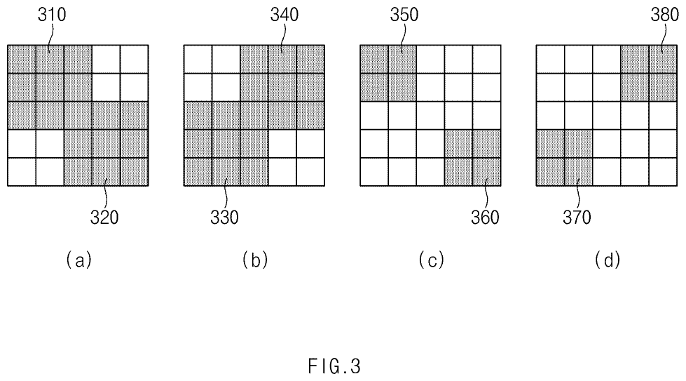

FIG. 1 is a block diagram illustrating an example of an image processing device according to an embodiment of the present disclosure. FIG. 2 is a diagram illustrating an example of a checkered pattern according to an embodiment of the present disclosure. FIG. 3 is a diagram illustrating an example of a checkered pattern according to an embodiment of the present disclosure.

Hereinafter, the image processing device 100 of FIG. 1 according to embodiments of the present disclosure will be described with reference to FIGS. 2 and 3.

Referring to FIG. 1, the image processing device (for example, an image signal processor (ISP)) 100 may perform at least one image signal process on image data (IDATA) to generate the processed image data (IDATA_P).

The image processing device 100 may reduce noise of image data (IDATA), and may perform various kinds of image signal processing (e.g., demosaicing, defect pixel correction, gamma correction, color filter array interpolation, color matrix, color correction, color enhancement, lens distortion correction, etc.) for image-quality improvement of the image data. In addition, the image processing device 100 may compress image data that has been created by execution of image signal processing for image-quality improvement, such that the image processing device 100 can create an image file using the compressed image data. Alternatively, the image processing device 100 may recover image data from the image file. In this instance, the scheme for compressing such image data may be a reversible format or an irreversible format. As a representative example of such compression format, in the case of using a still image, Joint Photographic Experts Group (JPEG) format, JPEG 2000 format, or the like may be used. In addition, in the case of using moving images, a plurality of frames can be compressed according to Moving Picture Experts Group (MPEG) standards such that moving image files can be created.

The image data (IDATA) may be generated by an image sensing device (not shown) that captures an optical image of a scene, but the scope of the present disclosure is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some implementations of the present disclosure, it is assumed that the image data (IDATA) is generated by the image sensing device.

The pixel array may include a color filter array (CFA) in which color filters are arranged according to a predetermined pattern (e.g., a Bayer pattern, a quad-Bayer pattern, Nona-Bayer pattern, an RGBW pattern, etc.) so that each color filter can sense light of a predetermined wavelength band. The pattern of the image data (IDATA) may be determined according to the type of the pattern of the CFA.

The image processing device 100 may include a checkered pattern determiner 110, a diagonal pattern determiner 120, and/or a target pixel corrector 130.

The checkered pattern determiner 110 may determine whether a texture within a kernel including a target pixel has directionality of a predetermined checkered pattern.

The pixel array of the image sensing device may include defective pixels that cannot normally capture a color image due to process limitations or temporary noise inflow. In addition, the pixel array may include phase difference detection pixels configured to acquire phase difference-related information to implement the autofocus function. The phase difference detection pixels cannot acquire color images in the same manner as defective pixels. An image caused by pixels such as defective pixels and phase-difference detection pixels that make it impossible to obtain a normal color image needs to be corrected. In the present disclosure, pixels such as defective pixels and phase-difference detection pixels that make it impossible to obtain a normal color image will hereinafter be referred to as “target pixels”, and processes for correcting the target pixels will be described in detail.

A kernel may include a target pixel at a center portion thereof. In addition, the kernel may include a texture, and the texture may refer to a set (aggregate) of pixels having similarity. For example, a target subject having a similar color included in an image may be recognized as a texture within the kernel, but is not limited thereto. Referring to FIGS. 2 and 3, assuming that a (5×5) kernel exists, shaded portions in (a), (b), (c), and (d) of FIG. 2 and (a), (b), (c), and (d) of FIG. 3 may be textures.

The texture within the kernel may have directionality. Specifically, the texture within the kernel may have directionality corresponding to a horizontal direction, a vertical direction, a diagonal direction (e.g., a slash direction ‘/’, i.e., a direction from the right-upper side to the left-lower side, a backslash direction ‘\’, i.e., a direction from the left-upper side to the right-lower side, etc.). In addition, the texture within the kernel may have directionality of a checkered pattern in which a horizontal texture and a vertical texture are mixed. For example, a texture 210 of a first row of the kernel of FIG. 2(a) may have directionality of a horizontal orientation, and a texture 220 of a first column of the kernel of FIG. 2(a) may have directionality of a vertical orientation, so that the texture of the kernel of FIG. 2(a) may have directionality of a checkered pattern. In addition, a texture of a first row 230 of the kernel of FIG. 2(b) may have directionality of a horizontal orientation, and a texture of the last column 240 may have directionality of a vertical orientation, so that a texture of the kernel of FIG. 2(b) may have directionality of a checkered pattern. In addition, a texture 250 of the last row of the kernel of FIG. 2(c) may have horizontal directionality and a texture 260 of the last column of the kernel of FIG. 2(c) may have vertical directionality, so that the texture of the kernel of FIG. 2(c) may have directionality of a checkered pattern. In addition, a texture 270 of the last row of the kernel of FIG. 2(d) may have horizontal directionality and a texture 280 of a first column the kernel of FIG. 2(d) may have vertical directionality, so that a texture of the kernel of FIG. 2(d) may have directionality of a checkered pattern. In addition, since the kernels of FIGS. 3(a), 3(b), 3(c), and 3(d) include vertical textures and horizontal textures, it can be understood that the textures (310˜380) having a checkered pattern directionality are included in the kernels of FIG. 3. However, the scope of examples of kernels including textures having the checkered pattern directionality is not limited to those described above.

The checkered pattern determiner 110 may determine whether the texture has the directionality of a predetermined checkered pattern based on the sum of vertical gradients (hereinafter referred to as a vertical gradient sum) of at least some pixels of the kernel, the sum of horizontal gradients (hereinafter referred to as a horizontal gradient sum) of at least some pixels of the kernel, the sum of slash-directional gradients (hereinafter referred to as a slash-directional gradient sum) of at least some pixels of the kernel, and the sum of backslash-directional gradients (hereinafter referred to as a backslash-directional gradient sum) of at least some pixels of the kernel. The gradient may represent a difference between pixel values, and the gradient sum may represent a value obtained by summing difference values of the pixel values. A more detailed description of the method of calculating the gradient sum is described herein below with reference to the attached drawings.

The checkered pattern determiner 110 may determine whether the texture has the directionality of a predetermined checkered pattern based on whether a first direction corresponding to a maximum gradient sum from among the vertical gradient sum, the horizontal gradient sum, the slash-directional gradient sum, and the backslash-directional gradient sum is perpendicular to a second direction corresponding to a minimum gradient sum from among the vertical gradient sum, the horizontal gradient sum, the slash-directional gradient sum, and the backslash-directional gradient sum.

In addition, the checkered pattern determiner 110 may determine whether the texture has the directionality of a predetermined checkered pattern based on whether a value obtained by multiplying the minimum gradient sum among the vertical gradient sum, the horizontal gradient sum, the slash-directional gradient sum, and the backslash-directional gradient sum by a first ratio is greater than the remaining gradient sums excluding the minimum gradient sum. A more detailed description of the method for determining the directionality of the texture based on the vertical gradient sum, the horizontal gradient sum, the slash-directional gradient sum, and the backslash-directional gradient sum is described herein below with reference to the attached drawings.

In addition, the checkered pattern determiner 110 may determine whether the texture has the directionality of a predetermined checkered pattern based on the first gradient sum for the first row of the kernel, the second gradient sum for the first column of the kernel, the third gradient sum for the last column of the kernel, and the fourth gradient sum for the last row of the kernel. Specifically, the checkered pattern determiner 110 may determine whether the texture has directionality of a predetermined checkered pattern based on a first sum value, a second sum value, a third sum value, and a fourth sum value. In this instance, the first sum value may be obtained by summing the first gradient sum, the second gradient sum, a portion of the third gradient sum, and a portion of the fourth gradient sum, the second sum value may be obtained by summing the first gradient sum, the third gradient sum, a portion of the second gradient sum, and a portion of the fourth gradient sum, a third sum value may be obtained by summing the third gradient sum, the fourth gradient sum, a portion of the first gradient sum, and a portion of the second gradient sum, and a fourth sum value may be obtained by summing the second gradient sum, the fourth gradient sum, a portion of the first gradient sum, and a portion of the third gradient sum. For example, the checkered pattern determiner 110 may determine whether the texture has directionality of a predetermined checkered pattern based on a first sum value, a second sum value, a third sum value, and a fourth sum value. Here, the first sum value may be obtained by summing a first gradient sum for the first row of the kernel of FIG. 2(a), a second gradient sum for a first column of the kernel of FIG. 2(a), a portion of a third gradient sum for the last column of the kernel of FIG. 2(a), and a portion of a fourth gradient sum for the last row of the kernel of FIG. 2(a), a second sum value may be obtained by summing the first gradient sum of the kernel of FIG. 2(b), the third gradient sum of the kernel of FIG. 2(b), a portion of the second gradient sum of the kernel of FIG. 2(b), and a portion of the fourth gradient sum of the kernel of FIG. 2(b), a third sum value may obtained by summing the third gradient sum of the kernel of FIG. 2(c), the fourth gradient sum of the kernel of FIG. 2(c), a portion of the first gradient sum of the kernel of FIG. 2(c), and a portion of the second gradient sum of FIG. 2(c), and a fourth sum value may be obtained by summing the second gradient sum of the kernel of FIG. 2(d), the fourth gradient sum of the kernel of FIG. 2(d), a portion of the first gradient sum of the kernel of FIG. 2(d), and a portion of the third gradient sum of the kernel of FIG. 2(d). More specific details on how to calculate the gradient sums and the sum values described above are described herein below with reference to the attached drawings.

In addition, the checkered pattern determiner 110 may determine whether the texture has the directionality of a predetermined checkered pattern based on whether a minimum sum value among the first to fourth sum values is less than the value obtained by multiplying an average brightness (luminance) value of the kernel by a second ratio.

In addition, the checkered pattern determiner 110 may determine whether the texture has the directionality of a predetermined checkered pattern based on whether a value obtained by subtracting a minimum sum value among the first to fourth sum values from a maximum sum value among the first to fourth sum values is greater than a value obtained by multiplying the average luminance value of the kernel by a third ratio. The checkered pattern determiner 110 may calculate an average luminance value of the kernel using the average value of the values obtained by removing an offset value (e.g., a pedestal offset value) from pixel values of the green pixels belonging to the kernel. More specific details of the method of determining the directionality of the texture are described herein below with reference to the attached drawings.

The diagonal pattern determiner 120 may determine whether the texture within the kernel has the directionality of a diagonal pattern (hereinafter referred to as diagonal pattern directionality). For example, the diagonal pattern determiner 120 may determine which direction is associated with the minimum gradient sum among the vertical gradient sum of at least some pixels of the kernel, the horizontal gradient sum of at least some pixels, the slash-directional gradient sum of at least some pixels, and the backslash-directional gradient sum of at least some pixels. In addition, the diagonal pattern determiner 120 may determine whether the sum of gradients of adjacent pixels of a target pixel and gradients of other pixels located in a diagonal direction of the adjacent pixels is greater than a value obtained by multiplying the average luminance value of the kernel by a fourth ratio. In addition, the diagonal pattern determiner 120 may determine whether the sum (hereinafter referred to as a diagonal gradient sum) of gradients of pixels located in the diagonal direction is greater than the average luminance value of the kernel. Specifically, in a situation in which the slash-directional gradient sum among the vertical gradient sum of at least some pixels of the kernel, the horizontal gradient sum of at least some pixels of the kernel, the slash-directional gradient sum of at least some pixels of the kernel, and the backslash-directional gradient sum of at least some pixels of the kernel is the smallest, when the fifth (slash-directional) gradient sum of adjacent pixels of the target pixel and other pixels located in the slash direction of the adjacent pixels of the target kernel is greater than a value obtained by multiplying the average luminance value of the kernel by a fourth ratio, and the slash-directional gradient sum of the adjacent pixels and other pixels located in the slash direction is greater than the average luminance value of the kernel, the diagonal pattern determiner 120 may determine that the texture does not have diagonal pattern directionality.

In a situation in which the backslash-directional gradient sum among the vertical gradient sum of at least some pixels of the kernel, the horizontal gradient sum of at least some pixels of the kernel, the slash-directional gradient sum of at least some pixels of the kernel, and the backslash-directional gradient sum of at least some pixels of the kernel is the smallest, when the sixth (backslash-directional) gradient sum of adjacent pixels of the target pixel and other pixels located in the backslash direction of the adjacent pixels of the target kernel is greater than a value obtained by multiplying the average luminance value of the kernel by a fourth ratio, and the backslash-directional gradient sum of the adjacent pixels and other pixels located in the backslash direction is greater than the average luminance value of the kernel, the diagonal pattern determiner 120 may determine that the texture does not have diagonal pattern directionality. More specific details of the method for determining whether the texture has the diagonal pattern directionality are described herein below with reference to the attached drawings.

The target pixel corrector 130 may correct the target pixel based on the determination result obtained by the checkered pattern determiner or the diagonal pattern determiner. For example, if it is determined that the texture has the directionality of a predetermined checkered pattern, the target pixel corrector 130 may correct the target pixel based on a third direction corresponding to a second smallest gradient sum from among the vertical gradient sum of at least some pixels of the kernel, the horizontal gradient sum of at least some pixels of the kernel, the slash-directional gradient sum of at least some pixels of the kernel, and the backslash-directional gradient gum of at least some pixels of the kernel. Specifically, the target pixel corrector 130 may correct the target pixel using an average value of pixel values of pixels that are located in the third direction based on the target pixel and have the same color as the target pixel.

In addition, if it is determined that the texture does not have the directionality of a predetermined checkered pattern and does not have the directionality of a diagonal pattern, the target pixel corrector 130 may correct the target pixel based on a fourth direction corresponding to a smaller gradient sum from among the vertical gradient sum of at least some pixels of the kernel and the horizontal gradient sum of at least some pixels of the kernel. Specifically, the target pixel corrector 130 may correct the target pixel using the average value of pixel values of pixels that are located in a fourth direction based on the target pixel and have the same color as the target pixel.

If it is determined that the texture does not have the directionality of a predetermined checkered pattern and has the directionality of a diagonal pattern, the target pixel corrector 130 may correct the target pixel using the average value of pixel values of pixels having the same color as the target pixel included in the kernel. In addition, if it is determined that the texture does not have the directionality of the predetermined checkered pattern and has the directionality of the diagonal pattern, the target pixel corrector 130 may correct the target pixel using a median value of pixel values of pixels having the same color as the target pixel within the kernel. In addition, if it is determined that the texture does not have the directionality of a predetermined checkered pattern but has the directionality of a diagonal pattern, the target pixel corrector 130 may correct the target pixel based on a direction corresponding to a minimum gradient sum among a vertical gradient sum of at least some pixels of the kernel, a horizontal gradient sum of at least some pixels of the kernel, a slash-directional gradient sum of at least some pixels of the kernel, and a backslash-directional gradient sum of at least some pixels of the kernel. More specific details of the method for correcting the target pixel are described herein below with reference to the attached drawings.

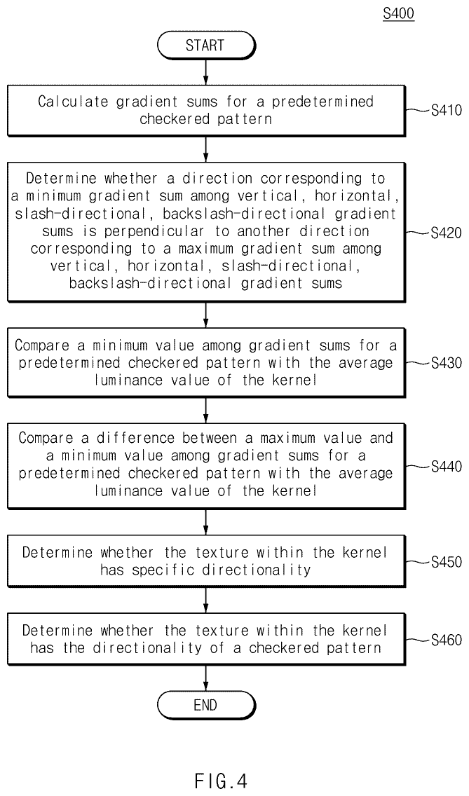

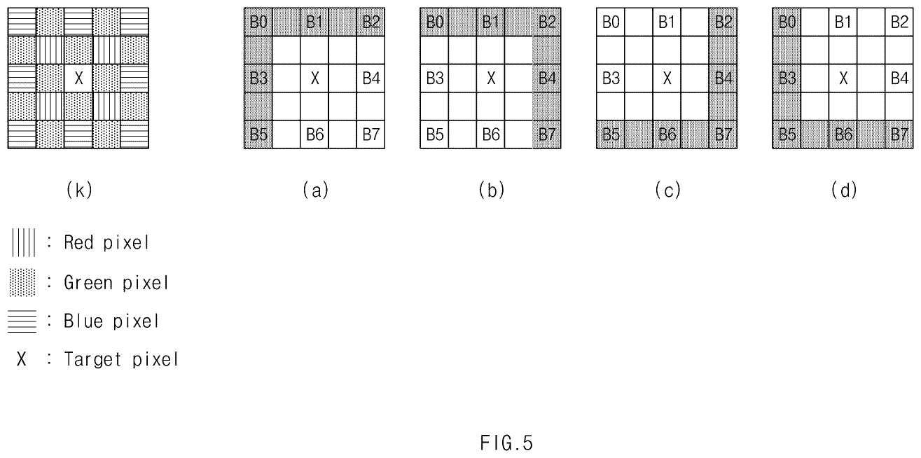

FIG. 4 is a flowchart illustrating an example of an image processing method S400 according to an embodiment of the present disclosure. FIG. 5 is a schematic diagram illustrating example operations of the image processing method S400 according to an embodiment of the present disclosure.

Hereinafter, the image processing method S400 of FIG. 4 will be described with reference to FIG. 5.

Referring to FIG. 4, the image processing method S400 may determine whether a texture included in a kernel has the directionality of a predetermined checkered pattern. In operation S410, the image processing method may calculate gradient sums for a predetermined checkered pattern. Referring to FIG. 5, the predetermined checkered pattern may refer to a checkered pattern such as (a), (b), (c), and (d) of FIG. 5, but is not limited thereto. The kernel of FIG. 5(k) may represent a (5×5) kernel in which a central pixel corresponding to the position of a blue pixel among the Bayer pattern is a target pixel, and the kernel of FIG. 5(a), 5(b), 5(c), or 5(d) may also be the same as in FIG. 5(k). Reference symbols (B0, B1, B2, B3, B4, B5, B6, B7) shown in (a), (b), (c), and (d) of FIG. 5 may represent pixel values of blue pixels. The gradient sum for a given checkered pattern may represent, for example, a first sum value obtained by summing a first gradient sum for a first row corresponding to a texture in the kernel of FIG. 5(a), a second gradient sum for a first column corresponding to the texture, a portion of a third gradient sum of the last column corresponding to the texture, and a portion of a fourth gradient sum of the last row corresponding to the texture.

Specifically, the first gradient sum may represent a value obtained by summing a difference value between B0 and B1 and a difference value between B1 and B2. In addition, the second gradient sum may represent a value obtained by summing a difference value between B0 and B3 and a difference value between B3 and B5. The third gradient sum may represent a value obtained by summing a difference value between B2 and B4 and a difference value between B4 and B7. The fourth gradient sum may represent the sum of a difference value between B5 and B6 and a difference value between B6 and B7. The first sum value may represent the sum of a difference value between B0 and B1, a difference value between B1 and B2, a difference value between B0 and B3, a difference value between B3 and B5, a difference value between B4 and B7, and a difference value between B6 and B7. If the first sum value is expressed as “diff_check1”, “diff_check1” may be represented by Equation 1 below.

$$diff\_check1 = abs ( B 0 - B 1 ) + abs ( B 1 - B 2 ) + abs ( B 0 - B 3 ) + abs ( B 3 - B 5 ) + abs ( B 4 - B 7 ) + abs ( B 6 - B 7 ) \qquad [ Equation 1 ]$$

In addition, the gradient sum for a given checkered pattern may refer to a second sum value that is obtained by summing the first gradient sum for the first row corresponding to a texture in the kernel of FIG. 5(b), a portion of the second gradient sum for the first column corresponding to the texture, a portion of the third gradient sum for the last column corresponding to the texture, and a portion of the fourth gradient sum for the last row corresponding to the texture. Specifically, the second sum value may refer to a value that is obtained by summing the difference value between B0 and B1, the difference value between B1 and B2, the difference value between B2 and B4, the difference value between B4 and B7, the difference value between B3 and B5, and the difference value between B5 and B6. When the second sum value is expressed as “diff_check2”, “diff_check2” may be represented by Equation 2 below.

$$diff\_check 2 = abs ( B 0 - B 1 ) + abs ( B 1 - B 2 ) + abs ( B 2 - B 4 ) + abs ( B 4 - B 7 ) + abs ( B 3 - B 5 ) + abs ( B 5 - B 6 ) \qquad [ Equation 2 ]$$

In addition, the gradient sum for a given checkered pattern may refer to a third sum value that is obtained by summing a portion of the first gradient sum for the first row corresponding to a texture in the kernel of FIG. 5(c), a portion of the second gradient sum for the first column corresponding to the texture, a portion of the third gradient sum for the last column corresponding to the texture, and a portion of the fourth gradient sum for the last row corresponding to the texture. Specifically, the third sum value may refer to a value that is obtained by summing the difference value between B2 and B4, the difference value between B4 and B7, the difference value between B5 and B6, the difference value between B6 and B7, the difference value between B0 and B1, and the difference value between B0 and B3. When the third sum value is expressed as “diff_check3”, “diff_check3” may be represented by Equation 3 below.

$$diff\_check 3 = abs ( B 2 - B 4 ) + abs ( B 4 - B 7 ) + abs ( B 5 - B 6 ) + abs ( B 6 - B 7 ) + abs ( B 0 - B 1 ) + abs ( B 0 - B 3 ) \qquad [ Equation 3 ]$$

In addition, the gradient sum for a given checkered pattern may mean a fourth sum value that is obtained by summing a portion of the first gradient sum for the first row corresponding to a texture in the kernel of FIG. 5(d), a portion of the second gradient sum for the first column corresponding to the texture, a portion of the third gradient sum for the last column corresponding to the texture, and a portion of the fourth gradient sum for the last row corresponding to the texture. Specifically, the fourth sum value may be a value that is obtained by summing a difference value between B0 and B3, a difference value between B3 and B5, a difference value between B5 and B6, a difference value between B6 and B7, a difference value between B1 and B2, and a difference value between B2 and B4. When the fourth sum value is expressed as “diff_check4”, “diff_check4” may be represented by Equation 4 below.

$$diff\_check 4 = abs ( B 0 - B 3 ) + abs ( B 3 - B 5 ) + abs ( B 5 - B 6 ) + abs ( B 6 - B 7 ) + abs ( B 1 - B 2 ) + abs ( B 2 - B 4 ) \qquad [ Equation 4 ]$$

Although the above embodiment has disclosed that the gradient sums are calculated based on the blue pixels for convenience of description, other implementations are also possible. Even when the pixel corresponding to the central pixel of the kernel is a green pixel or a red pixel, the gradient sums may be calculated using the above-described method by using pixels having the same color as the color corresponding to the central pixel. However, the method for calculating the gradient sum according to the embodiment of the present disclosure is not limited to using pixel values of pixels of the same color.

In operation S420, the image processing method may determine whether the direction corresponding to a minimum gradient sum among the vertical gradient sum, the horizontal gradient sum, the slash-directional gradient sum, and the backslash-directional gradient sum is perpendicular (or orthogonal) to the direction corresponding to a maximum gradient sum among the vertical gradient sum, the horizontal gradient sum, the slash-directional gradient sum, and the backslash-directional gradient sum. When the vertical gradient sum is the minimum gradient sum and the horizontal gradient sum is the maximum gradient sum, the vertical direction corresponding to the minimum gradient sum and the horizontal direction corresponding to the maximum gradient sum may be determined to be orthogonal to each other. When a texture having a single directionality is included in the kernel, rather than textures having multiple directionalities, such as a checkered pattern, the direction corresponding to the minimum gradient sum and the direction corresponding to the maximum gradient sum are likely to be orthogonal to each other. Therefore, if the direction corresponding to the minimum gradient sum and the direction corresponding to the maximum gradient sum are not orthogonal, this identifies an example case in which the texture does not have a specific directionality in the same manner as in the checkered pattern.

In an instance in which the condition in which the direction corresponding to the minimum gradient sum is perpendicular to the direction corresponding to the maximum gradient sum is referred to as a first condition (cond_not_90 degree), when the direction corresponding to the minimum gradient sum is expressed as “dir_1^{st}”, the direction corresponding to the maximum gradient sum is expressed as “dmax”, and the gradient sums for the four directions are expressed as “4-dir gradient sum”, the first condition (cond_not_90 degree) may be represented by Equation 5 below.

$$cond\_not \_ 90 degree = \text{!orthogonal} ( dir\_ {1}^{st} , dmax ) \qquad [ Equation 5 ]$$

In Equation 5, “dir_1^{st}” may be equal to “MIN(4−dir gradient sum)” (i.e., dir_1^{st}=MIN(4−dir gradient sum)), and “dmax” may be equal to “MAX(4−dir gradient sum)” (i.e., dmax=MAX(4−dir gradient sum)).

At this time, the vertical gradient sum, the horizontal gradient sum, the slash-directional gradient sum, and the backslash-directional gradient sum can be calculated using at least some (e.g., pixels of the same color) of the pixels in the kernel, and there is no limitation on the method of calculating the gradient sums in the four directions.

The image processing method (S430) may compare the minimum value among the gradient sums for a given checkered pattern with the average luminance value of the kernel. The gradient sums for the given checkered pattern may refer to the first to fourth sum values as described above. The checkered pattern corresponding to the minimum sum value among the first to fourth sum values may be a pattern most similar to the pattern of the texture of the corresponding kernel. For example, when the first sum value is the minimum sum value, the corresponding kernel may include a texture of a pattern similar to that of FIG. 5(a). In addition, as the minimum sum value is reduced, the probability that the kernel has a pattern corresponding to the checkered pattern corresponding to the minimum sum value may increase. Therefore, the image processing method may compare the minimum sum value with the average luminance value of the kernel, and may determine whether the probability that the kernel does not have a specific directionality in the same manner as in the checkered pattern is high. In addition, the image processing method may determine whether the texture has the directionality of a predetermined checkered pattern based on whether the minimum sum value is smaller than a value obtained by multiplying the average luminance value of the kernel by a second ratio. When the condition that the minimum sum value is smaller than the value obtained by multiplying the average luminance value of the kernel by the second ratio is referred to as a second condition, the second ratio may be a user parameter for adjusting the second condition. When the second condition is referred to as “cond_check_min_ratio”, the second condition may be represented by Equation 6 below.

$$cond\_check \_min \_ratio = ( min\_check < avg\_grn \_blc \times r\_th \_checker \_min \_ratio ) \qquad [ Equation 6 ]$$

In Equation 6, “min_check” is equal to “MIN(diff_check1˜4)” (i.e., min_check=MIN(diff_check1˜4), “avg_grn_blc” denotes the average luminance value of the kernel, and “r_th_check_min_ratio” denotes the second ratio.

The average luminance value of the kernel may be calculated based on the average value of the pixel values of the green pixels in the kernel. For example, the average luminance value of the kernel may be an average value of values obtained by removing the offset value from the pixel values of the green pixels, but the method of calculating the average luminance value of the kernel is not limited thereto.

In operation S440, the image processing method may compare a difference between the maximum and minimum values among the gradient sums for the predetermined checkered pattern with the average luminance value of the kernel. The gradient sums for the predetermined checkered pattern may be the first to fourth sum values as described above. In addition, the image processing method may determine whether the texture has the directionality of a predetermined checkered pattern based on whether a difference between the maximum sum value and the minimum sum value among the first to fourth sum values is greater than the value obtained by multiplying the average luminance value of the kernel by a third ratio. As the difference between the maximum sum value and the minimum sum value increases, the kernel may be more likely to contain textures with a particular checkered pattern. For example, when the first sum value is the minimum sum value, as a difference between the first sum value and the maximum sum value becomes greater than a predetermined value, the corresponding kernel may be more likely to contain the texture with a pattern similar to that of FIG. 5(a). When the condition that the difference between the maximum sum value and the minimum sum value is greater than the value obtained by multiplying the luminance value of the kernel by a third ratio is referred to as the third condition, and the third condition is referred to as “cond_check_minmax_ratio”, the third condition may be represented by Equation 7 below.

$$cond\_check \_minmax \_ratio = ( ( max\_check - min\_check ) > avg\_grn \_blc \times r\_th \_checker \_minmax \_ratio ) \qquad [ Equation 7 ]$$

In Equation 7, “max_check” is equal to “MAX(diff_check1˜4)” (i.e., max_check=MAX(diff_check1˜4)), “avg_grn_blc” denotes the average luminance value of the kernel, and “r_th_check_minmax_ratio” denotes the third ratio. The third ratio may be a user parameter for adjusting the third condition.

In step S450, the image processing method may determine whether the texture in the kernel has a specific directionality. Specifically, the image processing method may determine whether the texture has strong directionality in any one of the vertical direction, the horizontal direction, the slash direction, and the backslash direction. For example, the image processing method may determine whether the texture has a specific directionality by determining whether the value obtained by multiplying the minimum gradient sum among the vertical gradient sum, the horizontal gradient sum, the slash-directional gradient sum, and the backslash-directional gradient sum by the first ratio is greater than the remaining gradient sums excluding the minimum gradient sum. If a value obtained by multiplying the minimum gradient sum by the first ratio is greater than the remaining gradient sums except for the minimum gradient sum, this means that the magnitude of the minimum gradient sum is not significantly smaller than the remaining gradient sums, so that the texture within the kernel does not have a strong directionality in a specific direction. For example, assuming that the vertical gradient sum is the minimum gradient sum, if the value obtained by multiplying the vertical gradient sum by the first ratio is greater than the horizontal gradient sum, the slash-directional gradient sum, and the backslash-directional gradient sum, it may be determined that the texture within the kernel does not have strong directionality in the vertical direction. The condition that the value obtained by multiplying the minimum gradient sum among the vertical gradient sum, the horizontal gradient sum, the slash-directional gradient sum, and the backslash-directional gradient sum by the first ratio is greater than the remaining gradient sums except for the minimum gradient sum may be referred to as a fourth condition. When the fourth condition is referred to as “cond_check_str_dir”, the fourth condition may be represented by Equation 8 below.

$$cond\_check \_str \_dir = ( r\_th \_checker \_str \_dir \times dir\_ {1}^{s t} > other\_gradien \_sums ) \qquad [ Equation 8 ]$$

In Equation 8, “dir_1^{st}” is equal to “MIN(4−dir gradient sum)” (i.e., dir_1^{st}=MIN(4−dir gradient sum)), “other_gradient_sums” denotes a gradient sum for three directions excluding “dir_1^{st}” among the vertical gradient sum, the horizontal gradient sum, the slash-directional gradient sum, and the backslash-directional gradient sum, and “r_th_check_str_dir” denotes a first ratio. Here, the first ratio may be a user parameter for adjusting the fourth condition.

In operation S460, the image processing method may determine whether the texture in the kernel has the directionality of a checkered pattern. Specifically, the image processing method may determine whether the texture in the kernel has the directionality of a predetermined checkered pattern based on whether the first to fourth conditions are satisfied. For example, the image processing method may determine that the texture in the kernel has the directionality of a predetermined checkered pattern when all of the first to fourth conditions are satisfied. Specifically, when the first direction corresponding to a maximum gradient sum among four-directional gradient sums is perpendicular to the second direction corresponding to a minimum gradient sum among the four-directional gradient sums (when the first condition is satisfied), the image processing method determines that the image does not have a specific directionality (e.g., determines that the image has the same directionality as a predetermined checkered pattern). When a minimum sum value among the first to fourth sum values is smaller than the value obtained by multiplying the average luminance value of the kernel by the second ratio (when the second condition is satisfied), the image processing method may determine that the kernel is likely to include the texture of the checkered pattern corresponding to the minimum sum value. When a difference between the maximum sum value and the minimum sum value among the first to fourth sum values is greater than the value obtained by multiplying the average luminance value of the kernel by the third ratio (when the third condition is satisfied), the image processing method may determine that the kernel is likely to include the texture of the predetermined checkered pattern. When the value obtained by multiplying the minimum gradient sum among the four-directional gradient sums by the first ratio is greater than the remaining gradient sums excluding the minimum gradient sum (when the fourth condition is satisfied), the image processing method may determine that the kernel does not have a specific directionality. As a result, it may be determined that the texture within the kernel has the directionality of a given checkered pattern.

When the condition that the texture within the kernel has directionality of a predetermined checkered pattern is referred to as “homo_checker”, “homo_checker” may be represented by Equation 9 below.

$$homo\_checker = cond\_not \_ 90 degree \& cond\_check \_min \_ratio \& cond\_check \_minmax \_ratio \& cond\_check \_str \_dir \qquad [ Equation 9 ]$$

In this embodiment, the meaning of ‘&’ may indicate that all of the conditions cond_not_90 degree, cond_check_min_ratio, cond_check_minmax_ratio, and cond_check_str_dir are satisfied. Although the method for determining that the texture within the kernel has the directionality of a predetermined checkered pattern when all of the first to fourth conditions are satisfied has been described for convenience of description, the scope of the image processing method is not limited thereto, and it may be determined that the texture has the directionality of a predetermined checkered pattern when at least some of the first to fourth conditions are satisfied.

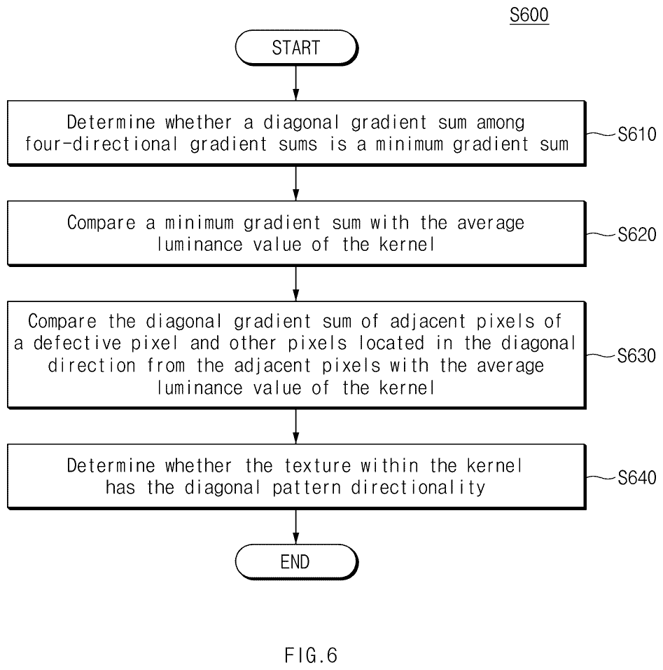

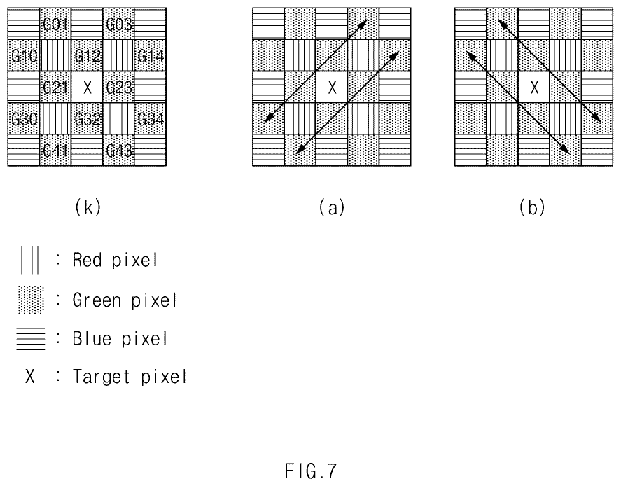

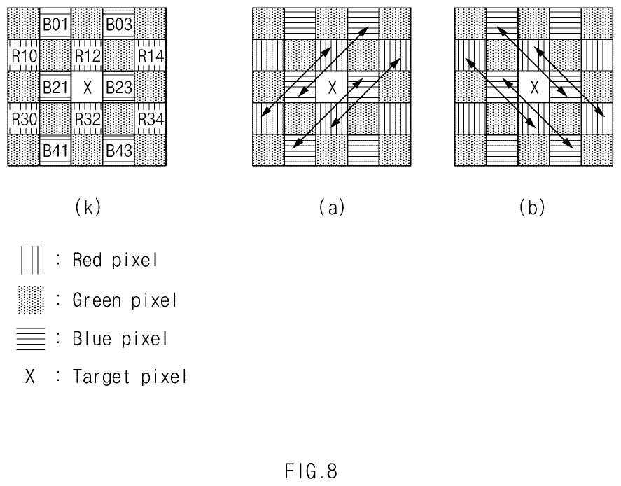

FIG. 6 is a flowchart illustrating an example of the image processing method S600 according to an embodiment of the present disclosure. FIG. 7 is a schematic diagram illustrating example operations of the image processing method according to an embodiment of the present disclosure. FIG. 8 is a schematic diagram illustrating example operations of the image processing method according to an embodiment of the present disclosure.

Hereinafter, the image processing method S600 of FIG. 6 according to embodiments of the present disclosure will be described in detail with reference to FIGS. 2 and 3.

Referring to FIG. 6, the image processing method S600 according to an embodiment of the present disclosure may determine whether the texture in the kernel has diagonal pattern directionality. Specifically, in operation S610, the image processing method may determine whether the diagonal gradient sum among the four-directional gradient sums is the minimum gradient sum. In other words, the image processing method may determine whether either the slash-directional gradient sum or the backslash-directional gradient sum among the vertical gradient sum, the horizontal gradient sum, the slash-directional gradient sum, and the backslash-directional gradient sum is the minimum gradient sum.

In operation S620, the image processing method may compare the minimum gradient sum with the average luminance value of the kernel if the diagonal gradient sum is the minimum gradient sum. Specifically, the image processing method may determine whether the slash-directional gradient sum is greater than the average luminance value of the kernel if the slash-directional gradient sum is the minimum gradient sum. In addition, the image processing method may determine whether the backslash-directional gradient sum is greater than the average luminance value of the kernel if the backslash-directional gradient sum is the minimum gradient sum.

In operation S630, the image processing method may compare the diagonal gradient sum of adjacent pixels of the target pixel and other pixels located in the diagonal direction from the adjacent pixels with the average luminance value of the kernel. Specifically, the image processing method may determine whether the fifth (slash-directional) gradient sum of adjacent pixels of the target pixel and other pixels located in the slash direction from the adjacent pixels is greater than the value obtained by multiplying the average luminance value of the kernel by the fourth ratio. Referring to FIG. 7, (k) of FIG. 7 may be a (5×5) kernel in which the central pixel corresponding to the blue pixel is the target pixel. In this instance, the adjacent pixels of the target pixel may be green pixels corresponding to G12, G21, G23, and G32. In addition, FIG. 7(a) illustrates the adjacent pixels of the target pixel and other pixels located in the slash direction from the adjacent pixels of the target pixel. Specifically, the adjacent pixels of the target pixel and the pixels located in the slash direction from the adjacent pixels of the target pixel may be green pixels corresponding to G03, G12, G21, G30, G14, G23, G32, and G41. A fifth (slash-directional) gradient sum of the adjacent pixels of the target pixel and the pixels located in the slash direction from the adjacent pixels of the target pixel may be the sum of a difference between G03 and G12, a difference between G12 and G21, a difference between G21 and G30, a difference between G14 and G23, a difference between G23 and G32, and a difference between G32 and G41. When the fifth gradient sum is referred to as “diff_no_dia1”, the fifth gradient sum may be represented by Equation 10 below.

$$diff\_no \_dia 1 = abs ( G 03 - G 12 ) + abs ( G 12 - G 21 ) + abs ( G 21 - G 30 ) + abs ( G 14 - G 23 ) + abs ( G 23 - G 32 ) + abs ( G 32 - G 41 ) \qquad [ Equation 10 ]$$

Referring to FIG. 8, FIG. 8(k) illustrates a (5×5) kernel in which the central pixel corresponding to the green pixel is the target pixel. The adjacent pixels of the target pixel may be red pixels and blue pixels corresponding to R12, B21, B23, and R32. FIG. 8(a) illustrates adjacent pixels of the target pixel and pixels located in the slash direction from the adjacent pixels of the target pixel. Specifically, the adjacent pixels of the target pixel and the pixels located in the slash direction from the adjacent pixels may be red pixels and blue pixels corresponding to B03, R12, B21, R30, R14, B23, R32, and B41. The fifth (slash-directional) gradient sum of the adjacent pixels of the target pixel and the pixels located in the slash direction from the adjacent pixels of the target pixel may be a value calculated based on the difference between B03 and B21, the difference between B23 and B41, the difference between R12 and R30, and the difference between R14 and R32. Specifically, the fifth gradient sum may be calculated by multiplying the gradients for the blue pixels by the blue gain, multiplying the gradients for the red pixels by the red gain, and multiplying the sum of the gradient sums for the blue pixels multiplied by the blue gain and the gradient sums for the red pixels multiplied by the red gain by a predetermined ratio. The blue gain may refer to an average value of the pixel values of all blue pixels compared to an average value of the pixel values of all green pixels in the previous frame. In addition, the red gain may mean an average value of the pixel values of all red pixels with respect to an average value of the pixel values of all green pixels in the previous frame. A predetermined ratio may be a value for matching the number of gradients used to calculate the fifth gradient sum when the central pixel corresponds to the blue pixel or the red pixel to the number of gradients used to calculate the fifth gradient sum when the central pixel corresponds to the green pixel. For example, as described above with respect to the (5×5) kernel, when the central pixel corresponds to a red pixel or a blue pixel, the total number of gradients used to calculate the fifth gradient sum is 6, and when the central pixel corresponds to a green pixel, the total number of gradients used to calculate the fifth gradient sum is 4, so that the predetermined ratio described above may be 3/2, but is not limited thereto. In a situation where the fifth gradient sum is referred to as “diff_no_dia1”, when the predetermined ratio is set to 3/2, the blue gain is “B_gain”, and the red gain is “R_gain”, the fifth gradient sum may be represented by Equation 11 below.

$$diff\_no \_dia1 = [ \{ abs ( B 03 - B 21 ) + abs ( B 23 - B 41 ) \} \times B\_gain + \{ abs ( R 12 - R 30 ) + abs ( R 14 - R 32 ) \} \times R\_gain ] \times 3 / 2 \qquad [ Equation 11 ]$$

The image processing method may determine whether the sixth (backslash-directional) gradient sum of adjacent pixels of the target pixel and other pixels located in the backslash direction from the adjacent pixels of the target pixel is greater than the value obtained by multiplying the average luminance value of the kernel by the fourth ratio. Referring to FIG. 7, the adjacent pixels of the target pixel may be green pixels corresponding to G12, G21, G23, and G32. In addition, FIG. 7(b) illustrates the adjacent pixels of the target pixel and the pixels located in the backslash direction from the adjacent pixels of the target pixel. Specifically, the adjacent pixels of the target pixel and the pixels located in the backslash direction from the adjacent pixels of the target pixel may be green pixels corresponding to G01, G12, G23, G34, G10, G21, G32, and G43. A sixth (backslash-directional) gradient sum of adjacent pixels of the target pixel and other pixels located in the backslash direction from the adjacent pixels of the target pixel may be the sum of a difference between G01 and G12, a difference between G12 and G23, a difference between G23 and G34, a difference between G10 and G21, a difference between G21 and G32, and a difference between G32 and G43. When the sixth gradient sum is referred to as “diff_no_dia2”, the sixth gradient sum may be represented by Equation 12 below.

$$diff\_no \_dia 2 = abs ( G 01 - G 12 ) + abs ( G 12 - G 23 ) + abs ( G 23 - G 34 ) + abs ( G 10 - G 21 ) + abs ( G 21 - G 32 ) + abs ( G 32 - G 43 ) \qquad [ Equation 12 ]$$

Referring to FIG. 8, adjacent pixels of the target pixel may be red pixels and blue pixels corresponding to R12, B21, B23, and R32. In addition, FIG. 8(b) illustrates adjacent pixels of the target pixel and other pixels located in the backslash direction from the adjacent pixels of the target pixel. Specifically, the adjacent pixels of the target pixel and other pixels located in the backslash direction from the adjacent pixels of the target pixel may be red pixels and blue pixels corresponding to B01, R12, B23, R34, R10, B21, R32, and B43. A sixth (slash-directional) gradient sum of adjacent pixels of the target pixel and other pixels located in the backslash direction from the adjacent pixels of the target pixel may be a value calculated based on a difference between B01 and B23, a difference between B21 and B43, a difference between R10 and R32, and a difference between R12 and R34. Specifically, the sixth gradient sum may be calculated by multiplying gradients for blue pixels by a blue gain, multiplying gradients for red pixels by a red gain, and multiplying a value obtained by summing the gradient sum for blue pixels multiplied by the blue gain and the gradient sum for red pixels multiplied by the red gain by a predetermined ratio. The predetermined ratio may be a value for matching the number of gradients used to calculate the sixth gradient sum when the central pixel corresponds to the blue pixel or the red pixel to the number of other gradients used to calculate the sixth gradient sum when the central pixel corresponds to the green pixel. For example, as described above with respect to the (5×5) kernel, when the central pixel corresponds to a red pixel or a blue pixel, the total number of gradients used to calculate the sixth gradient sum is 6, and when the central pixel corresponds to a green pixel, the total number of gradients used to calculate the sixth gradient sum is 4, so that the predetermined ratio may be 3/2, but is not limited thereto. When the sixth gradient sum is referred to as “diff_no_dia2”, the predetermined ratio is 3/2, the blue gain is “B_gain”, and the red gain is “R_gain”, the sixth gradient sum may be represented by Equation 13 below.

$$diff\_no \_dia2 = [ \{ abs ( B 01 - B 23 ) + abs ( B 21 - B 43 ) \} \times B\_gain + \{ abs ( R 10 - R 32 ) + abs ( R 12 - R 34 ) \} \times R\_gain ] \times 3 / 2 \qquad [ Equation 13 ]$$

The image processing method may determine whether the fifth gradient sum or the sixth gradient sum is greater than the value obtained by multiplying the average luminance value of the kernel by the fourth ratio.

In operation S640, the image processing method may determine whether the texture in the kernel has diagonal pattern directionality. Specifically, when a fifth condition is satisfied, the image processing method may determine that the texture does not have diagonal pattern directionality. Here, under the fifth condition, the slash-directional gradient sum is the smallest among the vertical gradient sum, the horizontal gradient sum, the slash-directional gradient sum, and the backslash-directional gradient sum, the fifth gradient sum is greater than a value obtained by multiplying the average luminance value of the kernel by the fourth ratio, and the slash-directional gradient sum is greater than the average luminance value of the kernel. When the fifth condition is referred to as “cond_no_dia1”, the fifth condition may be represented by Equation 14 below.

$$cond\_no \_dia1 = ( dmin\_dir == d1\_sum ) \& ( diff\_no \_dia1 > ( avg\_grn \_blc ≪ 1 ) ) \& ( d1\_sum > avg\_grn \_blc ) \qquad [ Equation 14 ]$$

In Equation 14, “dmin_dir” is equal to “MIN(4−dir gradient sum)” (i.e., dmin_dir=MIN(4−dir gradient sum)), “d1_sum” denotes the slash-directional gradient sum, and “avg_grn_blc” denotes the average luminance value of the kernel. At this time, the fourth ratio is assumed to be 2, but is not limited thereto.

In addition, when a sixth condition is satisfied, the image processing method may determine that the texture does not have diagonal pattern directionality. Here, under the sixth condition, the backslash-directional gradient sum is the smallest among the vertical gradient sum, the horizontal gradient sum, the slash-directional gradient sum, and the backslash-directional gradient sum, the sixth gradient sum is greater than a value obtained by multiplying the average luminance value of the kernel by the fourth ratio, and the backslash-directional gradient sum is greater than the average luminance value of the kernel. When the sixth condition is referred to as “cond_no_dia2”, the sixth condition may be represented by Equation 15 below.

$$cond\_no \_ 2 = ( dmin\_dir == d2\_sum ) \& ( diff\_no \_dia2 > ( avg\_grn \_blc ≪ 1 ) ) \& ( d2\_sum > avg\_grn \_blc ) \qquad [ Equation 15 ]$$

In Equation 15, “dmin_dir” is equal to “MIN(4−dir gradient sum)” (i.e., dmin_dir=MIN(4−dir gradient sum)), “d2_sum” denotes the backslash-directional gradient sum, and “avg_grn_blc” denotes the average luminance value of the kernel. At this time, the fourth ratio is assumed to be 2, but is not limited thereto.

The image processing method may determine that the texture does not have the diagonal pattern directionality if either of the fifth and sixth conditions is satisfied. When the case where the texture does not have the diagonal pattern directionality is referred to as “cond_no_dia”, “cond_no_dia” may be represented by Equation 16 below.

$$cond\_no \_dia = ( cond\_no \_dia1 \vert cond\_no \_dia2 ) \qquad [ Equation 16 ]$$

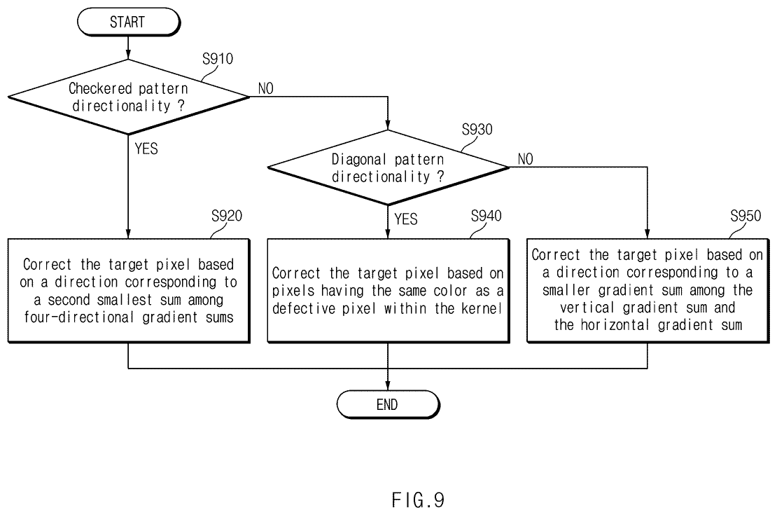

FIG. 9 is a flowchart illustrating an example of the image processing method according to an embodiment of the present disclosure.

Referring to FIG. 9, in operation S910, the image processing method may determine whether a texture within a kernel including a target pixel has the directionality of a predetermined checkered pattern. The operation S910 may correspond to the image processing method S400 of FIG. 4. For example, when the first to fourth conditions are satisfied, the image processing method may determine that the texture has the directionality of a predetermined checkered pattern. At this time, the predetermined checkered pattern may be any one of the checkered patterns illustrated in FIG. 2, but is not limited thereto.

If it is determined that the texture has a predetermined checkered pattern, in operation S920, the image processing method may correct the target pixel based on a direction corresponding to the second smallest gradient sum among the gradient sums of four directions. Specifically, when the direction corresponding to the second smallest gradient sum among the vertical gradient sum, the horizontal gradient sum, the slash-directional gradient sum, and the backslash-directional gradient sum is referred to as a third direction, the image processing method may correct the target pixel using the average value of pixel values of pixels that are located in the third direction based on the target pixel and have the same color as the target pixel. For example, when the second smallest gradient sum among the vertical gradient sum, the horizontal gradient sum, the slash-directional gradient sum, and the backslash-directional gradient sum is the vertical gradient sum, the third direction becomes the vertical direction, and the image processing method may correct the target pixel using the average value of pixel values of pixels having the same color as the target pixel among pixels located in the vertical direction with respect to the target pixel.

If it is determined that the texture does not have the directionality of a predetermined checkered pattern, the image processing method may determine whether the texture has the diagonal pattern directionality in operation S930. The operation S930 may correspond to the image processing method S600 of FIG. 6. Specifically, when at least one of the fifth condition and the sixth condition is satisfied, the image processing method may determine that the texture does not have the directionality of the diagonal pattern. In other words, when at least one of the fifth condition and the sixth condition is satisfied, the image processing method may determine that the texture has the directivity of any one of the checkered patterns illustrated in FIG. 3, rather than having the directionality of the diagonal pattern.

If it is determined that the texture has the diagonal pattern directionality, the image processing method may correct the target pixel based on pixels having the same color as the target pixel in the kernel in operation S940. In other words, the image processing method may determine that the texture has the diagonal pattern directionality when neither the fifth condition nor the sixth condition is satisfied, and may correct the target pixel based on pixels having the same color as the target pixel within the kernel. For example, the image processing method may correct the target pixel using the average value of pixel values of pixels having the same color as the target pixel within the kernel. The image processing method may correct the target pixel using a median value of pixel values of pixels having the same color as the target pixel within the kernel. In addition, the image processing method may correct the target pixel based on a direction corresponding to a minimum gradient sum among the vertical gradient sum, the horizontal gradient sum, the slash-directional gradient sum, and the backslash-directional gradient sum. For example, the image processing method may correct the target pixel using the average value of pixel values of pixels having the same color as the target pixel among pixels located in a direction corresponding to a minimum gradient sum based on the target pixel. When it is determined that the texture has the diagonal pattern directionality, the scope of the method of correcting the target pixel is not limited to what has been described above.

When it is determined that the texture does not have the diagonal pattern directionality, the image processing method may correct the target pixel based on a direction corresponding to a smaller gradient sum among the vertical gradient sum and the horizontal gradient sum in operation S950. For example, when the direction corresponding to a smaller gradient sum among the vertical gradient sum and the horizontal gradient sum is referred to as a fourth direction, the image processing method may correct the target pixel using the average value of pixel values of pixels that are located in the fourth direction with respect to the target pixel and have the same color as the target pixel.

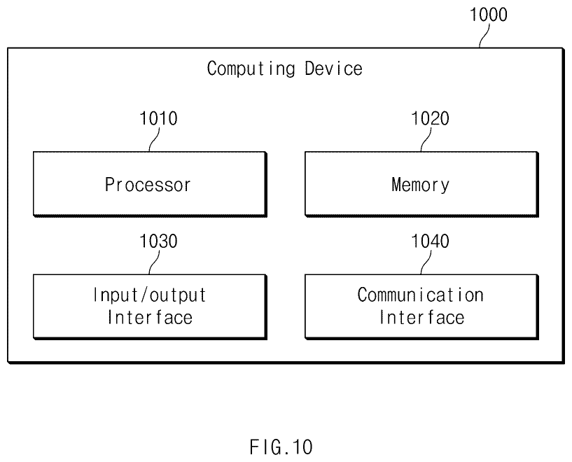

FIG. 10 is a block diagram showing an example of a computing device 1000 corresponding to the image processing device 100 of FIG. 1.

Referring to FIG. 10, the computing device 1000 may represent an embodiment of a hardware configuration for performing the operation of the image processing device 100 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the present disclosure is not limited thereto.

Additionally, the internal configuration or arrangement of the computing device 1000 and the image sensing device may vary depending on the embodiment. For example, at least a portion of the image sensing device may be included in the computing device 1000. Alternatively, at least a portion of the computing device 1000 may be included in the image sensing device. In this case, at least a portion of the computing device 1000 may be mounted together on a chip on which the image sensing device is mounted. The computing device 1000 may include a processor 1010, a memory 1020, an input/output (I/O) interface 1030, and a communication interface 1040.

The processor 1010 may process data and/or instructions required to perform the operations of the components of the image processing device 100 described in FIG. 1. That is, the processor 1010 may refer to the image processing device 100, but the scope of the present disclosure is not limited thereto.

The memory 1020 may store data and/or instructions required to perform operations of the components of the image processing device 100, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image processing device 100 disclosed in this document is recorded in the memory 1020 and executed and processed by the processor 1010, thereby implementing the operations of the image processing device 100.

The input/output (I/O) interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (e.g., an application processor, external memory, etc.), and may be a device that supports wired or wireless communication.

As is apparent from the above description, the image processing device according to the embodiments of the present disclosure may correct a target kernel belonging to a kernel that includes a texture having directionality of a checkered pattern.

The image processing device according to the embodiments of the present disclosure may determine whether a texture in a kernel has directionality of a checkered pattern.

The image processing device according to the embodiments of the present disclosure may correct a target pixel using pixels having the same color as the target pixel.

The image processing device according to the embodiments of the present disclosure may determine whether a texture in a kernel has directionality of a diagonal pattern.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in the present disclosure.

What is claimed is:

1. An image processing device comprising:
a checkered pattern determiner configured to determine whether a texture within a kernel including a target pixel has directionality of a predetermined checkered pattern;
a diagonal pattern determiner configured to determine whether the texture has directionality of a diagonal pattern when the texture does not have the directionality of the predetermined checkered pattern; and
a target pixel corrector configured to correct the target pixel based on a result of a determination obtained by the checkered pattern determiner and the diagonal pattern determiner.

2. The image processing device according to claim 1, wherein the checkered pattern determiner is configured to determine whether the texture has the directionality of the predetermined checkered pattern based on a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel.

3. The image processing device according to claim 2, wherein:
the checkered pattern determiner is configured to determine whether the texture has the directionality of the predetermined checkered pattern based on whether a first direction is perpendicular to a second direction;
wherein the first direction corresponds to a maximum gradient sum among the vertical gradient sum, the horizontal gradient sum, the slash-directional gradient sum, and the backslash-directional gradient sum; and
wherein the second direction corresponds to a minimum gradient sum among the vertical gradient sum, the horizontal gradient sum, the slash-directional gradient sum, and the backslash-directional gradient sum.

4. The image processing device according to claim 2, wherein the checkered pattern determiner is configured to determine whether the texture has the directionality of the predetermined checkered pattern based on whether a value, obtained by multiplying a minimum gradient sum among the vertical gradient sum, the horizontal gradient sum, the slash-directional gradient sum, and the backslash-directional gradient sum by a first ratio, is greater than remaining gradient sums excluding the minimum gradient sum.

5. The image processing device according to claim 1, wherein:
the checkered pattern determiner is configured to determine whether the texture has the directionality of the predetermined checkered pattern based on a first sum value, a second sum value, a third sum value, and a fourth sum value;
the first sum value is obtained by summing a first gradient sum for a first row of the kernel, a second gradient sum for a first column of the kernel, a portion of a third gradient sum for a last column of the kernel, and a portion of a fourth gradient sum for a last row of the kernel;
the second sum value is obtained by summing the first gradient sum, the third gradient sum, a portion of the second gradient sum, and a portion of the fourth gradient sum;
the third sum value is obtained by summing the third gradient sum, the fourth gradient sum, a portion of the first gradient sum, and a portion of the second gradient sum; and
the fourth sum value is obtained by summing the second gradient sum, the fourth gradient sum, a portion of the first gradient sum, and a portion of the third gradient sum.

6. The image processing device according to claim 5, wherein the checkered pattern determiner is configured to determine whether the texture has the directionality of the predetermined checkered pattern based on whether a minimum sum value among the first to fourth sum values is less than a value obtained by multiplying an average luminance value of the kernel by a second ratio.

7. The image processing device according to claim 6, wherein the checkered pattern determiner is configured to calculate the average luminance value of the kernel using an average value of values obtained by removing offset values from pixel values of green pixels within the kernel.

8. The image processing device according to claim 5, wherein the checkered pattern determiner is configured to calculate the first to fourth gradient sums using pixels having a same color as the target pixel.

9. The image processing device according to claim 5, wherein the checkered pattern determiner is configured to determine whether the texture has the directionality of the predetermined checkered pattern based on whether a value, obtained by subtracting a minimum sum value among the first to fourth sum values from a maximum sum value among the first to fourth sum values, is greater than a value obtained by multiplying an average luminance value of the kernel by a third ratio.

10. The image processing device according to claim 1, wherein the diagonal pattern determiner is configured to determine that the texture does not have the directionality of the diagonal pattern, when:
among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel, the slash-directional gradient sum is at a minimum value;
a fifth gradient sum of adjacent pixels of the target pixel and other pixels located in a slash direction from the adjacent pixels is greater than a value obtained by multiplying an average luminance value of the kernel by a fourth ratio; and
the slash-directional gradient sum is greater than the average luminance value of the kernel.

11. The image processing device according to claim 1, wherein the diagonal pattern determiner is configured to determine that the texture does not have the directionality of the diagonal pattern, when:
among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel, the backslash-directional gradient sum is at a minimum value;
a sixth gradient sum of adjacent pixels of the target pixel and other pixels located in a backslash direction from the adjacent pixels is greater than a value obtained by multiplying an average luminance value of the kernel by a fourth ratio; and
the backslash-directional gradient sum is greater than the average luminance value of the kernel.

12. The image processing device according to claim 1, wherein, when the texture has directionality of the predetermined checkered pattern, the target pixel corrector is configured to correct the target pixel based on a third direction, which corresponds to a second smallest gradient sum among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel.

13. The image processing device according to claim 12, wherein the target pixel corrector is configured to correct the target pixel using an average value of pixel values of pixels that are located in the third direction from the target pixel and have a same color as the target pixel.

14. The image processing device according to claim 1, wherein, when the texture does not have the directionality of the predetermined checkered pattern and the diagonal pattern, the target pixel corrector is configured to correct the target pixel based on a fourth direction, which corresponds to a smaller gradient sum among a vertical gradient sum of at least some pixels of the kernel and a horizontal gradient sum of the at least some pixels of the kernel.

15. The image processing device according to claim 14, wherein the target pixel corrector is configured to:
correct the target pixel using an average value of pixel values of pixels that are located in the fourth direction from the target pixel and have a same color as the target pixel.

16. The image processing device according to claim 1, wherein, when the texture has the directionality of the diagonal pattern, the target pixel corrector is configured to correct the target pixel using an average value of pixel values of pixels having a same color as the target pixel within the kernel.

17. The image processing device according to claim 1, wherein, when the texture has the directionality of the diagonal pattern, the target pixel corrector is configured to correct the target pixel using a median value of pixel values of pixels having a same color as the target pixel within the kernel.

18. The image processing device according to claim 1, wherein, when the texture has the directionality of the diagonal pattern, the target pixel corrector is configured to correct the target pixel based on a specific direction, which corresponds to a minimum gradient sum among a vertical gradient sum of at least some pixels of the kernel, a horizontal gradient sum of the at least some pixels of the kernel, a slash-directional gradient sum of the at least some pixels of the kernel, and a backslash-directional gradient sum of the at least some pixels of the kernel.

19. An image processing device comprising:
a checkered pattern determiner configured to determine whether a texture within a kernel including a target pixel has directionality of a predetermined checkered pattern based on a gradient sum of at least some pixels within the kernel including the target pixel; and
a target pixel corrector configured to correct, when the texture has the directionality of the predetermined checkered pattern, the target pixel based on a direction corresponding to a second smallest gradient sum among a vertical gradient sum of the at least some pixels, a horizontal gradient sum of the at least some pixels, a slash-directional gradient sum of the at least some pixels, and a backslash-directional gradient sum of the at least some pixels.

20. An image processing method comprising:
determining whether a texture within a kernel including a target pixel has directionality of a checkered pattern based on gradient sums for each of a first row, a last row, a first column, and a last column of the kernel including the target pixel; and
correcting the target pixel based on a result of the determining.
